(19) United States
(12) Patent Application Publication
(10) Pub. No.: US 2026/0317141 A1
(43) Pub. Date: Oct. 15, 2026

(54) DEFORMATION-BASED FORCE CONTROL FOR CLAMP ARMS

(71) Applicant: Cascade Corporation, Fairview, OR (US)

(72) Inventors: Christopher M. WALTHERS, Gresham, OR (US); Brent G. RUNNING, Hood River, OR (US)

(73) Assignee: Cascade Corporation, Fairview, OR (US)

(21) Appl. No.: 19/464,306

(22) Filed: Jan. 29, 2026

Related U.S. Application Data
(60) Provisional application No. 63/755,050, filed on Feb. 6, 2025.

(51) Int. Cl. B66F 9/18; B66F 9/06; B66F 9/075; B66F 9/22; F15B 11/028

(52) U.S. Cl. CPC B66F 9/18; B66F 9/0755; B66F 9/22; F15B 11/028; B66F 9/063

(57) ABSTRACT

Systems, devices, and methods for controlling the inward movement clamp arms of a material handling vehicle to grasp a deformable load, based on a monitored amount of deformation of the load.

### CROSS REFERENCE TO RELATED APPLICATIONS

This application claims the benefit of U.S. Provisional Patent Application No. 63/755,050 filed Feb. 6, 2025, the contents of which are hereby incorporated by reference in their entireties.

### BACKGROUND

The subject matter of this application relates to clamp arm attachments for material handling vehicles such as forklifts and/or Automatically Guided Vehicles (AGVs).

Material handling vehicles such as lift trucks or AGVs are used to pick up and move loads from one location to another. In particular, clamp arm attachments include a pair of opposed clamps intended to firmly grasp the lateral sides of a load so that the vehicle can raise the load and move it. Examples of this latter type of attachment include carton clamp attachments intended to grasp boxes or other rectangular loads, paper roll clamps intended to grasp cylindrical loads, etc. Lift truck attachments such as carton or roll clamp attachments need a hydraulic control system designed to avoid damaging the load. As one example, hydraulic control systems for clamp-type attachments need to provide a sufficient lateral force to securely grasp the load so that it does not fall during transport, but at the same time, not apply so much force on the load as to damage it. Hydraulic control systems for clamp attachments therefore typically include some type of control system that regulates gripping force by gradually increasing gripping fluid pressure automatically from a relatively low initial pressure to a pressure just sufficient to allow the load to be raised, without slipping.

Historically, these control systems monitor the pressure provided to the clamp cylinders to control the inward movement of the clamp arms. For example, a lift truck operator or AGV may have information about the weight and type of load to be grasped and lifted. Such information may be derived from predetermined values or alternately may be measured or sensed with load weight sensors, proximity sensors to determine size, etc. However these parameters are measured, they will determine a target pressure to be achieved in the clamp cylinders such that the pressure is sufficient to lift the load without dropping it, but not so high as to damage the load. The clamp arms will be brought together to contact the load until the target pressure is reached, at which point inward movement ceases and lifting may begin. Thereafter, pressure is continuously monitored to ensure that the achieved target pressure does not change during transport.

Due to the deformable nature of the material being grasped and lifted, one recurring problem with clamps is that they may easily damage the load when too much clamping pressure is applied. This problem is exacerbated by the fact that clamps are designed to handle rolls of differing geometries. For example, because the clamp pressure applied by the clamp pads of a pivoting arm clamp varies based on arm position, it is frequently difficult to apply the precise clamp force necessary to securely grasp the roll without damaging it. Furthermore, the deformation of the load may in some circumstances affect the magnitude of pressure required to hold the load.

What is desired, therefore, are improved devices, systems, and methods for controlling the operation of clamp arms of an industrial vehicle while grasping and carrying a deformable load.

### BRIEF DESCRIPTION OF THE DRAWINGS

For a better understanding of the invention, and to show how the same may be carried into effect, reference will now be made, by way of example, to the accompanying drawings, in which:

FIG. 1 shows an industrial lift truck attached to a roll clamp.

FIG. 2 shows electrical and hydraulic circuitry for operating the roll clamp of FIG. 1.

FIG. 3 shows an exemplary deformation-based control technique for controlling the operation of clamp arms upon a deformable load.

FIG. 4 shows a second exemplary deformation-based control technique for controlling the operation of clamp arms upon a deformable load

### DETAILED DESCRIPTION

The present disclosure pertains to novel devices, systems and methods for controlling the operation of clamp arms upon a load to be carried by a vehicle and, as noted earlier, this may be performed by a variety of vehicle types, such as but not limited to, a lift truck or an Automatically Guided Vehicle (AGV). For simplicity, the discloses systems and methods will be described in relation to an attachment for a lift truck, but those of ordinary skill in the art will appreciate that they may equally apply to any other type of vehicle or application e.g., a controller for clamp arms of an AGV

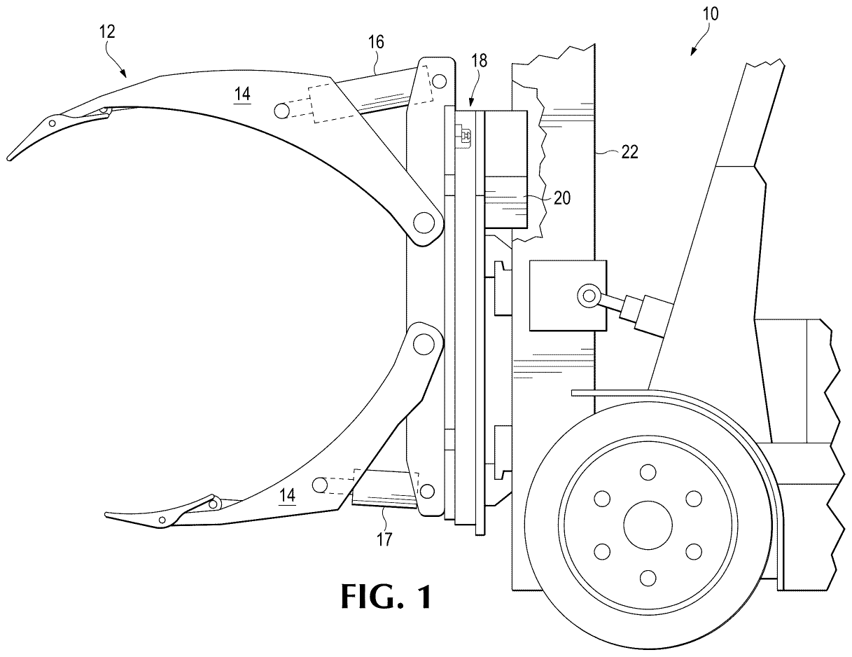

Referring to FIG. 1, a lift truck 10 may be attached to a roll clamp 12 used to clamp and unclamp cylindrical objects such as large paper rolls, using rotatable pivoted arm clamps 14 actuated by hydraulic cylinders 16 and 17. Though FIG. 1 shows only one cylinder 16 and one cylinder 17, the roll clamp 12 may include two cylinders 16 and two cylinders 17, where the cylinders not shown are located behind the cylinders 16 and 17 that are shown. If desired, rotation of the clamps 14 may be achieved by a rotator 18, which rotates the clamp bidirectionally about a longitudinal axis in response to a bidirectional hydraulic motor 20. While the roll clamp 12 includes separate cylinders 16 and 17 by which the clamp arms 14 may be independently actuated, some roll clamps have only a single pair of cylinders 16 to actuate one of the clamp arms 14, while the clamp arm 14 not actuated by the cylinders 16 is fixed.

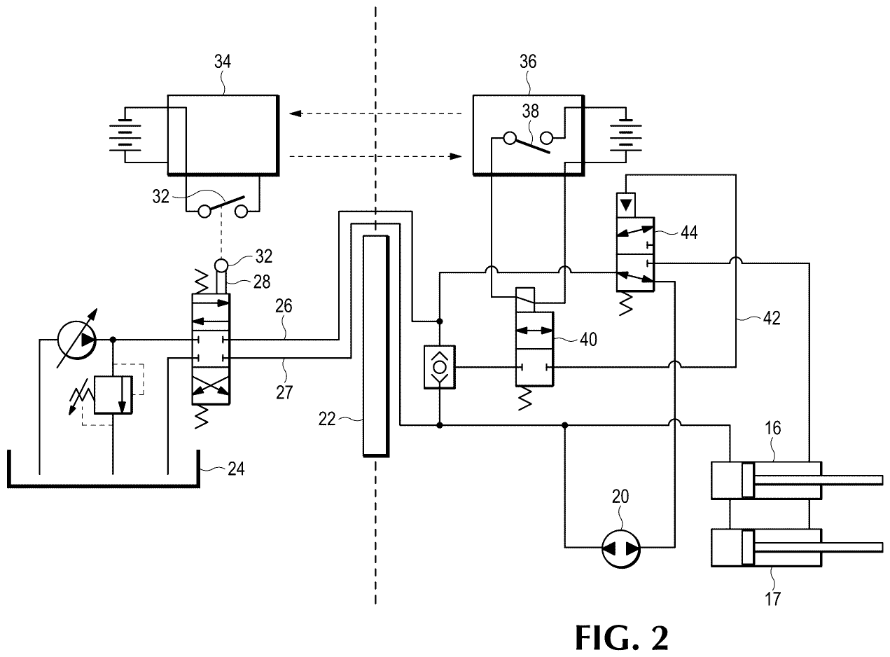

As seen in FIG. 2, hydraulic fluid from a reservoir 24 is exchanged between the lift truck 10 and the roll clamp 12 via two hydraulic lines 26 and 27 that extend over the mast 22 of the lift truck 10. A handle 28 on the lift truck 10 may permit an operator to alternately open or close the clamp arms 14 via actuation of the cylinders 16 and 17, and also permits an operator to rotate the clamps 14 in either selected one of a clockwise or counterclockwise direction via a rotator motor 30. A switch 32 located on the handle 28 is used to determine which function (rotation or clamping) is controlled by the handle 28. The switch 32 is integrated into a wireless transmitter 34 that is in communication with a wireless receiver 36 having a corresponding switch 38 in the roll clamp 12. Thus, for example, an operator can wirelessly cause the switch 38 to operate a spring-biased solenoid valve 40 between an open position and a closed position.

In the open position (as depicted in FIG. 2), pressurized fluid is directed from the reservoir 24 in the lift truck 10, through lines 26, 27 and over the mast 22 to operate the rotator motor 30 in either of two rotational directions depending on the position of the handle 28, i.e. by determining the direction of the flow through the lines 26, 27. Conversely, when the operator uses the switch 38 to wirelessly activate the solenoid valve 40, fluid from the reservoir 24 flows through a pilot line 42 to cause selector control valve 44 to redirect fluid from the rotator motor 30 to the clamp cylinders 16. In this configuration, operation of the handle 28 will alternatively extend or retract the cylinders 16 depending on the position of the handle 28, i.e. by determining the direction of the flow through the lines 26, 27. If a third hydraulic function, such as extending or retracting cylinders 17 were also included, a second pilot-operated valve assembly similar to the combination of valves 40 and 44 would be provided for control of piston and cylinder assemblies 17, together with a second transmitter/receiver set such as 34 and 36, and a second operator-controlled electrical switch 32.

Closure of clamp arms upon a load typically involves a feedback process where pressure is provided to the hydraulic cylinders that move the clamp arms inward towards a load. This continues until a point in time shortly after the arms contact the load; once contact has occurred, fluid pressure in the line feeding the clamp cylinders quickly rises as inward movement of the clamp arms resists the load. When the pressure has risen to a threshold amount, determined as providing the appropriate force on the load that will be sufficient to grasp it, but not damage it, then the control system ceases to provide further pressure. This latter function may be provided in a number of ways, such as by manual operation, or automatic operation using e.g., an electrically-controlled solenoid valve, a check valve that closes under pilot pressure, etc.

The assumption underlying this feedback process is that, after contacting a load, clamp force can rise to a value that is both sufficient to lift the load, given its weight, and not damage the load. If, for example, a deformable load is so heavy that the clamp force needed to lift the load would be too great to avoid damaging it, then the control system would be inadequate. This scenario is usually avoidable by reducing the dimensions (mass) of the material to be lifted simultaneously. A more intractable issue arises when the material to be lifted is simply too deformable.

Hydraulically actuated paper roll clamps, for example, require fluid pressure in order to simply power the arms through free space. Within a typical installation the pressure required to move the arms through free space is approximately 40 bar (600 psi). The actual magnitude of fluid pressure required to power arms through free space is mostly a function of hydraulic flow rate supplied and plumbing/valving flow restriction. Mechanical attachment friction also contributes to a lesser degree.

So long as the force needed to both securely clamp (lifting) and handle (not damage) the paper roll load requires an input pressure in excess of this minimum of typically 40 bar, the arms can be powered through free space until contact with the load is achieved and then pressure can be modulated upwards to achieve the intended clamping force. The specific pressure delivered to the attachment depends on geometry of a particular clamp and the particular needs of the load.

When forces applied to paper roll loads require delivering less than 40 bar while clamping the load, the force control method described above becomes impractical. Specifically, some loads are of lightweight materials that deform very easily, and may become damaged by clamp forces less than the force generated at the moment the clamp arms contact the load. Furthermore, stress relaxation of deformable materials may become an issue; as a material deforms under pressure for a period of time, the material's elasticity changes causing relaxation where the material tends to slip from the clamp arms as it becomes less elastic over time.

Therefore, alternative mechanisms for clamp arm control would be advantageous. Preferably, such alternatives would permit a wide variety of deformable loads to be securely carried without damage. Existing, pressure control systems, for example, involves handling a population of loads where the spectrum of load densities varies widely. Many of these loads require applied clamping force achieved by delivering pressure close to the maximum operating pressure of the attachment while other loads will suffer gross deformation if as little as 40 bar were to be supplied to the attachment while clamping.

Disclosed in this specification is a novel deformation-based control system for controlling clamp arms while securing a load to be carried. Specifically, rather than monitoring clamp pressure until a desired threshold is met, the disclosed control system monitors the deformation of the load and controls movement of the clamp arms using the detected deformation.

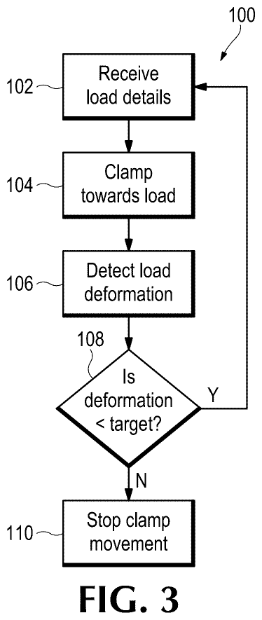

FIG. 3 shown an exemplary method 100 for implementing a deformation-based control system. The method 100 may be implemented, for example, in a control system for a lifting apparatus having opposed clamps that grasp a load, such as a lift truck or an AGV. In some embodiments, the method 100 would be implemented using hydraulic equipment, including hydraulically-actuated cylinders but those of ordinary skill in the art will also appreciate that other implementation could use clamps powered by electric motors or other such means. Regardless of the means for actuating the clamps, the control system preferably includes a processor and memory to receive load information, which may include for example, one or more of a type of load, the load weight, load dimensions, and one or more target amounts of load deformation to be applied by the clamps when handling the load.

At step 100, the details of the load to be carried are received. Such details preferably include one or more target amounts of load deformation to be applied by the clamps when handling the load. For example, the details preferably include a first target amount of deformation (e.g. a target percentage reduction in load volume) used to indicate a point at which further inward movement of the clamp arms, following initial contact with the load, should stop. Optionally, and as described later, load details may also include further target amounts of deformation to compensate or adjust for stress relaxation, slippage, etc. while the load is hoisted or transported. The respective target amounts of deformation are preferably empirically determined for different types of loads i.e., each type of load (tissue, newspaper, etc. may be measured to calculate one or more progressive amounts of deformation that are both sufficient for a clamp to lift/carry the load and do not permanently damage the load.

At step 204, the clamp arms are operated to close upon the load, and while this is occurring, at step 106 deformation of the load is monitored. Load deformation may be monitored and quantified in a wide variety of techniques. As one example, a touch sensor in combination with an encoder may monitor the displacement of the surface of the load. Alternatively, cameras or other sensors may feed image to an AI or other analysis engine.

At step 108, the detected amount of deformation is compared against the target specified in step 102 for ceasing inward clamp movement. If the measured deformation is less than the target, the procedure reverts to step 104. Conversely, if the measured deformation is at or exceeds the target, then at step 110 inward movement of the clamp arms cease.

As indicated previously, paper roll loads are known to exhibit a degree of elasticity, and the process of applying a predetermined level of deformation to a particular low-density load will produce a clamping force that is resisted by the load. Once the control circuitry has ceased inward movement of the clamp arms, for example by trapping pressure in the head side of the cylinders gripping the load, any changes in that elasticity will result in a diminished gripping force and risk the load slipping. For example, one known phenomenon associated with elastic materials, and in particular paper or tissue rolls, is stress relaxation where the material loses its elasticity after being deformed over a period of time, and this should manifest in a change of pressure in the clamp cylinders due to the reduced reactionary force exerted on the clamps by the load. Furthermore, other factors that potentially change the gripping force on the load over time include the static friction within the cylinder, the degree of positive sealing, presence of air within the hydraulic system, temperature change over time, etc.

Accordingly, some embodiments of the disclosed control systems and methods may monitor for such a change in gripping force even after the first target deformation has been reached, and after inward clamp movement has ceased, to determine whether the load needs to be further clamped to an additional target deformation. In such embodiments, pressure sensing devices may be fitted into the cylinders to continuously measure pressure, and monitor for changes in that pressure. Preferably, these pressure sensing devices would provide accurate readings as low as 1 bar with resolution equal to or better than 0.1 bar. Thus, following the application of a first predetermined level of load deformation, the pressure trapped within the cylinders will be used to monitoring the force applied by the attachment and resisted by the load, and determine whether additional load deformation needs to be applied.

All hydraulically actuated paper rolls clamps are affected by pressure trapped within the rod side of the attachment cylinder. Pressure present on the rod side of the cylinder will generate a force opposing the force generated by pressure applied to the head side of the piston. The opposing force will be a function of the rod side pressure and the rod side piston area and result in a net cylinder output force reduction.

Backpressure (rod side pressure) levels are generally negligible relative to the pressure applied to the head side and it is typically not necessary to directly factor them in to determining attachment supply pressure. However, when a very low level of pressure is trapped on the head side of the attachment cylinder, the pressure present on the rod side of the piston become relatively more significant and may therefore also be monitored.

One method for interpreting and accounting for the presence of rod side pressure utilizes the equation

$${P}_{Head} = {P}_{Target} + {P}_{rod} * {A}_{Ratio} or {P}_{Target} = {P}_{Head} - {P}_{rod} * {A}_{Ratio}$$

where P_{Head} is the head-side pressure of the cylinder, P_{rod} is the rod-side pressure of the cylinder, and A_{Ratio} is the ratio of the rod-side area to the head-side area of the cylinder. Once a load is clamped to the initial target deformation, this difference can establish a target pressure P_{Target} to monitor in the cylinder; if this monitored pressure degrades, then a stepwise increase in deformation may be applied to secure the load, and the procedure repeats. The amount of the stepwise increase in deformation may again be empirically determined based on the type of load.

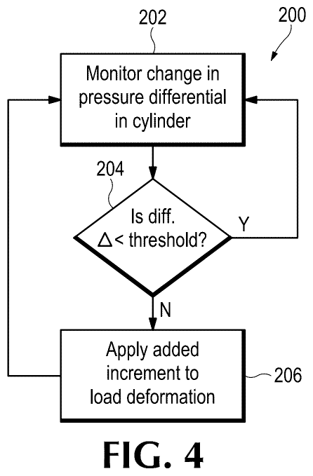

FIG. 4 shows such a method 200. Specifically, at step 202 pressure in the clamp cylinders is monitored. In preferred embodiments, the pressure differential between the rod and head sides of the cylinders is monitored to determine a change in net pressure exerted on the load. At step 204, if there is a change in this differential larger than a threshold, then at step 206 an additional increment of load deformation is applied and the method reverts to step 202 to monitor for an additional change in the pressure differential. Otherwise, at step 204 the method simply reverts to step 202.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A control system for a material handling vehicle having opposed clamps used to grasp a load, the control system operable to move the opposed clamps into the load based on feedback comprising a monitored amount of load deformation.

2. The control system of claim 1 operable to cease inward movement of the clamps when the monitored amount of load deformation reaches a first threshold.

3. The control system of claim 2 operable to renew inward movement of the clamp arms based on feedback of a measured pressure metric in at least one cylinder that actuates the clamp arms.

4. The control system of claim 3 where the measured pressure metric is a change in pressure differential between the rod side and the head side of the at least one cylinder.

5. The control system of claim 3 where the measured pressure metric is a change in pressure present in the at least one cylinder.

6. The control system of claim 3 where the renewed inward movement ceases when the measure pressure metric reaches a second threshold.

7. The control system of claim 1 capable of applying a pressure of less than 40 bar to the load when the clamp arms cease inward movement.

8. The control system of claim 1 integrated into a lift truck.

9. The control system of claim 1 integrated into an AGV.

10. The control system of claim 1 configured to alternately cease and resume inward clamp movement to a plurality of predetermined amounts of deformation based upon a plurality of associated thresholds.

11. A method for controlling opposed clamp arms on a material handling vehicle, the method comprising:
moving the clamp arms to grasp a load;
monitoring the deformation of the load once grasped; and
modulating the inward movement based on the monitored amount of deformation.

12. The method of claim 11 including cessation of inward movement of the clamps when the monitored amount of load deformation reaches a first threshold.

13. The method of claim 12 including renewing inward movement of the clamp arms based of a measured pressure metric in at least one cylinder that actuates the clamp arms.

14. The method of claim 13 where the measured pressure metric is a change in pressure differential between the rod side and the head side of the at least one cylinder.

15. The method of claim 13 where the measured pressure metric is a change in pressure present in the at least one cylinder.

16. The method of claim 13 where the renewed inward movement ceases when the measure pressure metric reaches a second threshold.

17. The method of claim 11 where a pressure of less than 40 bar is applied to the load when the clamp arms cease inward movement.

18. The method of claim 11 performed by a lift truck.

19. The method of claim 11 performed by an AGV.

20. The method of claim 11 including alternately ceasing and resuming inward clamp movement to achieve a plurality of predetermined amounts of deformation based upon a plurality of associated thresholds.
